(19) United States
(12) Patent Application Publication
(10) Pub. No.: US 2008/0217247 A1
(43) Pub. Date: Sep. 11, 2008

(54) METHOD OF SEPARATNG LIQUID MIXTURE

(75) Inventors: Makiko Niino, Nagoya-City (JP); Kenji Suzuki, Nagoya-City (JP); Toshihiro Tomita, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/121,032

(22) Filed: May 15, 2008

Related U.S. Application Data
(63) Continuation of application No. PCT/JP2006/320810, filed on Oct. 19, 2006.

(30) Foreign Application Priority Data
Jan. 11, 2006 (JP) 2006-003423

(51) Int. Cl. B01D 61/00

(52) U.S. Cl. 210/651

(57) ABSTRACT

A method of separating a liquid mixture selectively separate a substance having a molecular weight of 90 or more from a liquid mixture 31 by a separation membrane. The separation membrane is a MFI type zeolite membrane 2, the liquid mixture 31 is brought into contact with a face on one side of the MFI type zeolite membrane 2, and pressure is reduced on the other side of the MFI type zeolite membrane 2 to trap a membrane-permeable substance 32 permeating the MFI type zeolite membrane 2. The method of separating a liquid mixture can separate a predetermined substance from a liquid mixture without requiring high energy costs.

### TECHNICAL FIELD

The present invention relates to a method of separating liquid mixture. More specifically, the present invention relates to a method of separating a liquid mixture, the method being capable of separating a substance having a molecular weight of 90 or more from a liquid mixture without requiring high energy costs and being excellent in durability of a separation membrane in a separation treatment.

### BACKGROUND ART

Conventionally, for separation of a liquid mixture, there has industrially been employed separation by a solid adsorbent (see, e.g., Patent Document 1), distillation, a polymer membrane (see, e.g., Patent Document 2), or the like, in accordance with characteristics of the substances to be removed. Among these methods, separation by a solid adsorbent or distillation has a problem of requiring much energy for regeneration of the adsorbent or distillation. In addition, separation by a polymer membrane is less thermal resistant and less chemical resistant and, therefore, has a problem of limited application. Further, in the case of separating by the use of a polymer reverse osmosis membrane, there is a problem of requiring an operation pressure of several tens atmosphere because a pressure sufficient for surpassing osmotic pressure of a solution needs to be applied.

In contrast to such conventional methods, separation by a zeolite membrane is economically advantageous because much energy as the above distillation or the like requires is not required when a liquid mixture is separated (see, e.g., Patent Documents 3 to 5).

Patent Document 1: JP-A-05-220303

Patent Document 2: JP-A-07-275677

Patent Document 3: JP-A-07-185275

Patent Document 4: JP-A-2000-237561

Patent Document 5: JP-A-2003-144871

### DISCLOSURE OF THE INVENTION

The aforementioned zeolite is a kind of silicate having a net-like crystal structure where fine pores having a uniform diameter are formed, and it has been known that various kinds of chemical compositions shown by the general formula: WmZnO₂n·sH₂O (W: sodium, potassium, calcium, or the like, Z: silicon, aluminum, or the like, s is a real number of various kinds of values) are present and that many kinds (type) of crystal structures different in the pore shape are present. These zeolites have independent adsorbability, catalyst performance, solid acid property, ion exchangeability, and the like based on each chemical composition and crystal structure and has versatile applications such as an adsorbing material, catalyst, catalyst carrier, gas separation membrane, and ion exchanger. In recent years, zeolites have been studied for a liquid mixture separation membrane.

As a liquid mixture separation method using a zeolite membrane, there is disclosed a separation method using an A type zeolite membrane, an FER type zeolite membrane, or an MOR type zeolite membrane as described in the aforementioned Patent Documents 3 to 5. Of these, the A type zeolite membrane has a problem that it cannot be used for separation of acidic liquid mixture because a zeolite crystal structure is destroyed when the A type zeolite membrane is brought into contact with acid. In addition, since the FER type zeolite membrane and the MOR type zeolite membrane have strong hydrophilia, only water can permeate them, and, therefore, the FER type zeolite membrane and the MOR type zeolite membrane have a problem of being incapable of using for separation of, for example, organic acid from an organic solvent or the like contained in an aqueous solution.

The present invention has been made in view of the aforementioned problems and is characterized by providing a method of separating a liquid mixture, the method being capable of separating a substance having a molecular weight of 90 or more from a liquid mixture without requiring high energy costs and being excellent in durability of a separation membrane in a separation treatment. As a matter of course, since a substance having a molecular weight of below 90 permeates the MFI type zeolite membrane, the present method is also applicable to separation/condensation of a substance having a molecular weight of below 90.

In order to achieve the above aim, there are provided the following methods of separating a liquid mixture according to the present invention.

[1] A method of separating a liquid mixture, the method selectively separating a substance having a molecular weight of 90 or more from a liquid mixture by a separation membrane; wherein the separation membrane is a MFI type zeolite membrane, the liquid mixture is brought into contact with a face on one side of the MFI type zeolite, and pressure is reduced on the other side of the MFI type zeolite membrane to allow the substance having a molecular weight of below 90 to permeate the MFI type zeolite membrane.

[2] The method of separating a liquid mixture according to [1], wherein the liquid mixture is a solution containing an organic acid and/or a saccharide.

[3] The method of separating a liquid mixture according to [1] or [2], wherein the liquid mixture contains at least one kind selected from the group consisting of glucose, citric acid, malic acid, succinic acid, levulinic acid, and lactic acid.

[4] The method of separating a liquid mixture according to anyone of [1] to [3], wherein the liquid mixture contains at least one kind selected from the group consisting of isobutyric acid, normal butyric acid, propionic acid, and acetic acid.

[5] The method of separating a liquid mixture according to any one of [1] to [4], wherein the liquid mixture contains an organic solvent.

[6] The method of separating a liquid mixture according to any one of [1] to [5], wherein the liquid mixture contains water.

[7] The method of separating a liquid mixture according to [5] or [6], wherein the organic solvent is ethanol.

According to a method of separating a liquid mixture of the present invention, only by bringing the liquid mixture into contact with a face on one side of the MFI type zeolite and reducing pressure on the other side of the MFI type zeolite membrane, there can be obtained a liquid mixture separation method being capable of separating a substance having a molecular weight of 90 or more from the liquid mixture without requiring high energy costs and being excellent in durability of a separation membrane in a separation treatment.

### BRIEF DESCRIPTION OF THE DRAWINGS

FIG. 1 is a schematic view showing a separator used for a method of separating a liquid mixture of the present invention.

FIG. 2 is a cross-sectional view roughly showing a state that a support and silica sol are put in a pressure resistant container in a production process of an MFI type zeolite membrane used for a method of separating a liquid mixture of the present invention.

### REFERENCE NUMERALS

1: container for separation, 2: MFI type zeolite membrane, 3: main body of container, 4: bottomed cylindrical container, 5: lid, 6: inner cylinder (glass tube), 7: cooling tube, 8: thermometer, 9: stirrer, 10: union joint, 11: rubber plug, 12: container for heat medium, 13: bottom portion of inner cylinder, 14: trap, 15: pressure-reducing device, 16: pipe for reducing pressure, 17: thermal insulation pot, 21: space on liquid mixture side, 22: space on pressure reduction side, 31: liquid mixture, 32: membrane-permeable substance, 33: heat medium, 34: direction of pressure reduction, 35: liquid nitrogen, 41: pressure-resistant container, 42: alumina support, 44: fluorine resin inner cylinder, 45, 46: fixing jig, 47: porous support, 100: separator

### BEST MODE FOR CARRYING OUT THE INVENTION

The best mode for carrying out the present invention will hereinbelow be described specifically. However, the present invention is not limited to the following embodiment, and it should be understood that suitable modifications, improvements, and the like may be added thereto on the basis of a person of ordinary skill within a range of not deviating from the gist of the present invention.

(1) Separation Method

A method for separating a liquid mixture of the present invention is a method selectively separating a substance having a molecular weight of 90 or more from a liquid mixture by a separation membrane, where the separation membrane is a MFI type zeolite membrane, the liquid mixture is brought into contact with a face on one side of the MFI type zeolite, and pressure is reduced on the other side of the MFI type zeolite membrane to allow the substance having a molecular weight of below 90 to permeate the MFI type zeolite membrane to separate the liquid from the substance having a molecular weight of 90 or more. In the present invention, the MFI type zeolite used as a separation membrane is a zeolite where pores of about 0.5 nm are formed by an oxygen ten-membered ring in a crystal. The MFI type zeolite is generally used as an adsorbing material for adsorbing nitrogen oxides (NOx) hydrocarbon (HC), and the like in automobile exhaust gas or as a gas separation membrane or the like for selectively separating only p-xylene from xylene isomers. However, in the present invention, the MFI type zeolite is used as a separation membrane for separating a substance contained in a liquid mixture from the liquid mixture.

Since a method of separating a liquid mixture of the present invention thus uses a MFI type zeolite membrane as a separation membrane, the separation membrane has excellent durability in a separation treatment. This is because the MFI type zeolite has excellent chemical resistance. Since the MFI type zeolite has particularly excellent acid resistance, it exhibits excellent effect when an acidic liquid mixture is separated. In addition, the MFI type zeolite is used as a separation membrane in a method of separating a liquid mixture of the present invention, separation performance is hardly influenced by ionicity of a membrane-permeable substance. This is because a molecular sieve effect can be exhibited since the MFI type zeolite membrane does not have strong hydrophilia unlike the A type zeolite and because the MFI type zeolite membrane has a characteristic of allowing a substance having a specific molecular weight or less to permeate and not allowing the other substances having a higher molecular weight than the specific molecular weight to permeate the membrane.

In addition, a method of separating a liquid mixture of the present invention is conducted by a pervaporation technique, where the liquid mixture is brought into contact with a face on one side of the MFI type zeolite, and pressure is reduced on the other side (the pressure reduction side) of the MFI type zeolite membrane to allow the substance having a molecular weight of below 90 to permeate the MFI type zeolite membrane. Therefore, the method can separate a predetermined membrane-permeable substance without requiring high energy costs. At this time, pressure on one face side (liquid mixture side) of the MFI zeolite membrane is atmospheric pressure. Since a method of separating a liquid mixture of the present invention can separate a membrane-permeable substance without heating the liquid mixture at high temperature, the method is advantageous in energy costs over a separation method by distillation or the like.

The pressure on the other face side of the MFI type zeolite is preferably 8×10⁴ Pa or less, more preferably 10⁻² to 5×10⁴ Pa, and particularly preferably 10⁻¹ to 10⁴ Pa. In addition, it is preferable that a liquid mixture has a temperature of 20 to 100° C., more preferably 20 to 80° C., when the liquid mixture is separated by a pervaporation technique. Since a liquid mixture can be separated at such low temperature, separation can be conducted without using much energy. When the temperature is above 100° C., energy costs may become too high. When the temperature is below 20° C., separation may proceed slowly.

In a method of separating a liquid mixture of the present invention, it is preferable that a substance having a molecular weight of below 90 is separated from a liquid mixture containing a substance having a molecular weight of 90 or more and a substance having a molecular weight of below 90. When the liquid mixture is separated by a pervaporation technique using a MFI type zeolite membrane as a separation membrane in the case that the liquid mixture contains at least one kind of a substance having a molecular weight of below 90 and at least one kind of a substance having a molecular weight of 90 or more, the substance having a molecular weight of below 90 selectively permeates the separation membrane, and thus the substance having a molecular weight of below 90 can be separated. This is because, since the MFI type zeolite membrane does not have strong hydrophilia unlike the A type zeolite, a molecular sieve effect can be exhibited.

In a method of separating a liquid mixture of the present invention, the substance having a molecular weight of 90 or more contained in a liquid mixture is preferably a saccharide and/or an organic acid, and more preferably at least one kind selected from the group consisting of glucose, citric acid, malic acid, succinic acid, levulinic acid, and lactic acid. These high-molecular weight substances cannot permeate an MFI type zeolite membrane and remain on the liquid mixture side. Therefore, in this case, it is possible to selectively allow a low-molecular weight substance to permeate the separation membrane to separate the substance from the liquid mixture containing the low-molecular weight substance having a molecular weight of below 90 and the above high-molecular weight substance. On the other hand, in the case that the substance having a molecular weight of below 90% contained in the liquid mixture contains an organic acid, in particular, at least one kind selected from the group consisting of isobutyric acid, normal butyric acid, propionic acid, and acetic acid; these substances can be separated from the aforementioned high-molecular weight substances by allowing the substances to permeate the separation membrane according to a method of separating a liquid mixture of the present invention.

(2) Separator

In a method of separating a liquid mixture of the present invention, it is preferable that a liquid mixture is put in the space on the liquid mixture side of a container for separation provided with the aforementioned MFI type zeolite membrane and a main body of container separated into a space on one face side of the MFI type zeolite membrane (space on the liquid mixture side) and a space on the other face side (space on the pressure reduction side) to reduce the pressure on the pressure reduction side to be 8×10⁴ Pa or less. That is, the separator used for a method of separating a liquid mixture of the present invention is preferably provided with the aforementioned container for separation, a pressure-reducing device for reducing pressure in the space on the pressure reduction side via the aforementioned trap, and the trap for trapping the separated substance having a molecular weight of below 90. Each of the devices used for a method of separating a liquid mixture of the present invention will hereinbelow be described.

(2-1) Container for Separation

As described above, the container for separation is provided with an MFI type zeolite membrane and a main body of container where the MFI type zeolite membrane is disposed and which is divided into a space on one face side of the MFI type zeolite membrane (space on the liquid mixture side) and a space on the other face side (space on the pressure reduction side). In the main body of the container are formed the space on the liquid mixture side and the space on the pressure reduction side as described above. It is preferable that the MFI type zeolite membrane is disposed on at least a part of the boundary portion of these two spaces in such a manner that one face of the membrane faces the space on the liquid mixture side and the other face of the membrane faces the space on the pressure reduction side. It is preferable that the entire face on one side of the MFI type zeolite is immersed in the liquid mixture when the liquid mixture is put in the space on the liquid mixture side and that the state that the entire face on one side of the MFI type zeolite is immersed in the liquid mixture is maintained until the separation operation is completed.

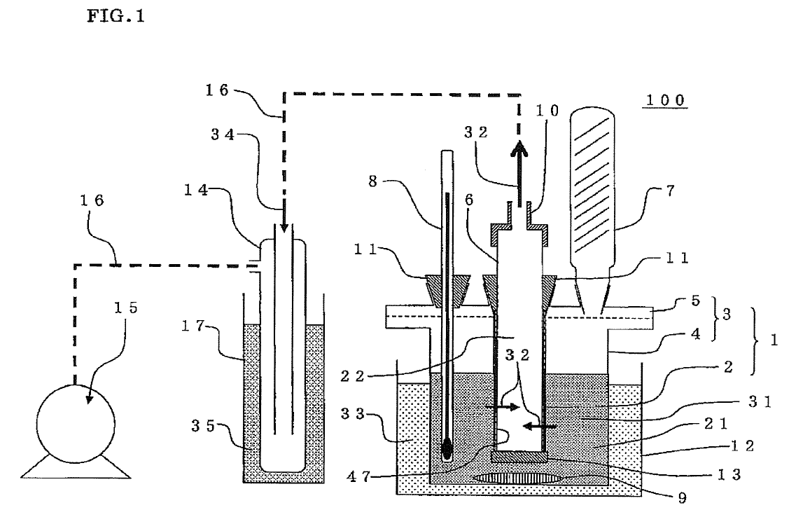

The structure of the container for separation is not particularly limited as long as the above conditions are satisfied. For example, as shown in FIG. 1, the container 1 for separation constituting the separator 100 has a structure provided with the main body of the container 3 and the porous support 47 having the MFI type zeolite membrane 2. An example of the main body 3 for the container has a bottomed cylindrical container 4 whose open portion is closed with a lid 5, a thermometer 8 inserted into the bottomed cylindrical container 4 through the lid 5, an inner cylinder 6 having a cylindrical shape, and a cooling tube 7. To the end portion on the side where the inner cylinder 6 is inserted into the bottomed cylindrical container 4 was bonded a porous support 47 having an MFI type zeolite membrane 2 formed thereon. The other end which is not bonded to the inner cylinder 6 of the porous support 47 having the MFI type zeolite membrane 2 formed thereon is sealed with the bottom portion 13 of the inner cylinder. The material and the shape of the bottom portion 13 of the inner cylinder are not particularly limited and can suitably be determined depending on nature of the liquid mixture and the like. As the inner cylinder 6 in a cylindrical shape, a glass tube or a stainless tube can be used. In this case, the space inside the bottomed cylindrical container 4 and outside the inner cylinder 6 serves as the space 21 on the liquid mixture side, and the space inside the inner cylinder 6 serves as the space 22 on the pressure reduction side. By thus forming the container 1 for separation, the liquid mixture 31 is put in the space 21 on the liquid mixture side to be brought into contact with one face of the MFI type zeolite membrane 2, pressure in the porous support 47 (space 22 on the pressure reduction side) is reduced to be predetermined pressure or less to trap the membrane-permeable substance 32 permeating the MFI type zeolite membrane 2 and entering the porous support 47 (space 22 on the pressure reduction side 22) from the space 21 on the liquid mixture side 21. In the case that the pressure in the porous support 47 is reduced by a pressure-reducing device via a trap, the membrane-permeable substance 32 flows outside through a pipe for reducing pressure from the inner cylinder 6 and trapped by the trap. In FIG. 1, the thermometer 8 and the inner cylinder 6 are passed through a rubber plug 11 and fixed to the lid 5 via the rubber plug 11. In addition, the container 1 for separation is put in a container 12 for heat medium containing a heat medium 33 so that the liquid mixture 31 may be heated by the heat medium 33. The liquid mixture 31 is stirred by a stirrer 9. The heated gas in the container 1 for separation is cooled by a cooling tube 7. In addition, as shown in FIG. 1, in the inner cylinder 6, an end portion on the side where the porous support 47 having a zeolite membrane 2 formed thereon is not disposed (end portion which is not immersed in the liquid mixture) is connected with a pipe 16 for reducing pressure by means of a union joint 10. It is preferable that the pipe 16 for reducing pressure is connected to the trap (trapping device) 14 and further connected to the pressure-reducing device 15 by means of the tube 16 for reducing pressure from the trap 14. Therefore, pressure in the inner cylinder 6 (space 22 on the pressure reduction side) is reduced by suction in a pressure reduction direction 34 by the pressure-reducing device 15 through the union joint 10.

The materials for the main body 3 for a container and the cooling tube 7 are not particularly limited and can suitably be determined according to nature of the liquid mixture and the like. For example, in the case that the liquid mixture contains acid; glass, stainless, or the like may be employed.

The MFI type zeolite membrane constituting a separation container used for a method of separating a liquid mixture of the present invention has a thickness of preferably 1 to 30 μm, and more preferably 2 to 15 μm. When it is thinner than 0.1 μm, a membrane defect is prone to be caused, and separation performance is prone to lower. When it is thicker than 30 μm, permeation of the membrane-permeable substance becomes slow, and membrane separation may take time. Here, the thickness of the zeolite membrane can be obtained by observing a cross section of the zeolite membrane with a scanning electronic microscope (SEM), and membrane thickness of 0.1 to 30 μm means the minimum membrane thickness of 0.1 μm or more and the maximum membrane thickness of 30 μm or less.

In FIG. 1, the MFI type zeolite membrane 2 is disposed on the outer surface of the porous support 47, and it is preferable that the MFI type zeolite membrane is thus disposed on the surface of the porous support. By disposing the membrane on the surface of the porous support, even if the zeolite membrane is formed to be thin, the membrane is supported by the support and therefore can maintain the shape to inhibit breakage or the like. The support is porous, and the material, shape, and size are not particularly limited as long as it can form a zeolite membrane and can appropriately be determined according to its application and the like. Examples of the material constituting the support include ceramics such as alumina (α-alumina, γ-alumina, anodized alumina, etc.), zirconia and metal such as stainless steel, and alumina is preferable from the viewpoint of production of a support and accessibility. Alumina obtained by forming and sintering alumina particles having an average particle size of 0.001 to 30 μm as a raw material is preferable. As a shape of the porous support, any shape may be employed, such as a plate-shape, a cylindrical shape, a tubular shape having a polygonal section, and a monolith shape.

In addition, a raw material tank (not illustrated) for storing a liquid mixture 31 and a pump (not illustrated) may be disposed outside the container 1 for separation in such a manner that the liquid mixture 31 circulates between the container 1 for separation and the raw material tank.

(2-2) Trap (Trapping Device)

As shown in FIG. 1, it is preferable that the trap 14 is connected with the nozzle 10 for reducing pressure of the container 1 for separation via the pipe 16 for reducing pressure and further connected with a pressure-reducing device 15 via the pipe 16 for reducing pressure. By this constitution, when a separation operation is conducted, the pressure-reducing device 15 is activated to reduce pressure in the trap 14 through the pipe 16 for reducing pressure, and further the pressure in the inner cylinder 6 (space on the pressure reduction side) of the container 1 for separation can be reduced to a predetermined pressure through the trap 14 and the pipe 16 for reducing pressure.

The material for the trap 14 is preferably resistant against pressure upon the pressure reduction operation in a method of separating a liquid mixture of the present invention. Examples of the material include glass and stainless steel. The structure of the trap 14 is not limited to the shape shown in the figure as long as the trap 14 has a structure capable of trapping a substance permeating the membrane with reducing the pressure in the inner cylinder 6 (space on the pressure reduction side) of the container 1 for separation to a predetermined pressure. In addition, in FIG. 1, the trap has a structure provided with a cylindrical (both the upper end portion and the lower end portion are closed) main body of the trap having a nozzle for reducing pressure formed on the side portion thereof and an inserted tube being inserted into the main body of the trap from one end portion of the main body of the trap and communicating the inside of the main body of the trap with the outside. In addition, as shown in FIG. 1, since the trap 14 traps with cooling steam of a membrane-permeable substance flowing therein, it is preferably disposed in a bottomed cylindrical thermal insulation pot 17 containing liquid nitrogen 35 serving as a cooling medium. The cooling medium is not particularly limited as long as the membrane-permeable substance 32 can be trapped by the trap 14 and suitably selected according to the kind of the membrane-permeable substance 32 and pressure inside the trap. Examples of the cooling medium include ice water, water, dry ice (solid carbon dioxide), dry ice and ethanol (or acetone, methanol), and liquid argon besides liquid nitrogen. In addition, as a thermal insulation pot 17, a container made of glass, stainless steel, or the like, may be used.

(2-3) Pressure-Reducing Device

The pressure-reducing device for reducing pressure inside the inner cylinder (space on the pressure reduction side) in the aforementioned container for separation is not particularly limited as long as the pressure in the space on the pressure reduction side can be reduced to a predetermined pressure or less. In addition, in order to adjust pressure in the space on the pressure reduction side, it is preferable to dispose a pressure controller in the pipe for reducing pressure between the pressure-reducing device and the trap. However, it may be disposed in the trap, in the pipe for reducing pressure between the trap and the container for separation, or in the container for separation.

Incidentally, a method for producing the MFI type zeolite membrane is not particularly limited and can be produced according to a method conventionally employed. For example, a method described in “Ind. Eng. Chem. Res. 2001, 40, 4069-4078” can be employed.

### EXAMPLE

The present invention will hereinbelow be described more specifically with Examples. However, the present invention is by no means limited to these Examples. The ratio of each substance is shown by ppm, which is based on mass.

### Example 1

### Production of MFI Type Zeolite Membrane

(1) Preparation of Membrane-Forming Sol

In a fluorine resin container of 250 ml were put 155.5 g of ion-exchange water and 29.05 g of 10 mass % tetrapropylammoniumhydroxy solution (produced by Wako Pure Chemical Industries, Ltd.), and they were mixed. Then, 17.5 g of tetraethylorthosilicate (produced by Aldrich Corporation) was further added to the mixture, followed by stirring at room temperature for three hours to obtain a membrane-forming sol.

(2) Formation of Zeolite Membrane

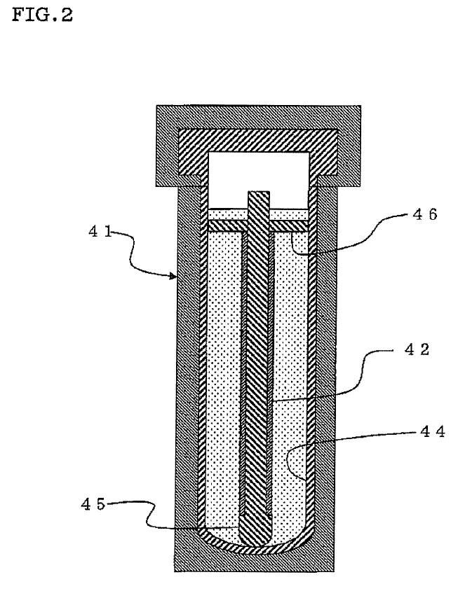

The obtained membrane-forming sol was put in a 300 ml stainless-steel pressure resistant container 41 having a fluorine resin inner cylinder 44 therein as shown in FIG. 2, and a cylindrical porous alumina support 42 having a diameter of 12 mm, a thickness of 1 to 2 mm, and a length of 160 mm was immersed in the sol to be allowed to react for 30 hours in a hot air drier at 185° C. The alumina support 42 was fixed to the pressure-resistant container 41 by fixing jigs 45 and 46. The fixing jig 45 is a stick-like jig whose tip is formed thick and inserted in a hole in the cylindrical alumina support 42 to fix the alumina support 42 in the state that the end portion formed to be thick of the fixing jig 45 faces downward. The fixing jig 46 is a plate-shaped jig having a hole for allowing the fixing jig 45 to pass through and fixes the upper end portion of the alumina support 42 in such a manner that the tip and the vicinity thereof (tip not formed thick) of the fixing jig 45 is inserted in the hole in the vicinity of the liquid surface of the liquid mixture. The support after reaction was subjected to boiling cleaning five times and then dried at 80° C. for ten minutes.

A cross section in a surface portion of the support after the reaction was observed with a scanning electronic microscope (SEM) to find a dense layer (zeolite membrane) having a thickness of about 10 μm formed on the surface of the porous alumina support 42. The dense layer was subjected to analysis by X-ray diffraction to confirm to be an MFI type zeolite crystal.

The obtained MFI type zeolite membrane formed on the porous alumina support was heated to 500° C. in an electric surface, and the temperature was kept for four hours to remove tetrapropylammonium to obtain a zeolite membrane formed on the surface of the support 42.

(Container for Separation)

A thermometer 3 and a cooling tube 7 were inserted in a lid 5 of a main body 3 of a container having a lid 5 and a bottomed cylindrical container 4 of a bottomed cylindrical shape having a capacity of 500 ml as shown in FIG. 1. Then, a glass bottom portion 13 of an inner cylinder was attached to an end portion of the porous support 47 having the aforementioned MFI type zeolite membrane 2 formed thereon, an inner cylinder (glass tube) 6 was connected to the other end portion, and the glass tube 6 was connected to a pipe 16 for reducing pressure by means of a stainless-steel union joint 10. The glass tube 6 was disposed in the lid 5 (main body 3 of the container) in the state that the glass tube 6 was inserted in a rubber plug 11 in such a manner that the bottom portion 13 of the inner cylinder is housed in the main body 3 of the container. A stirrer 9 for a magnetic stirrer was put in the main body 3 of the container so that the liquid mixture can be stirred.

(Separator for Liquid Mixture)

A separator 100 as shown in FIG. 1 was manufactured. That is, as shown in FIG. 1, the obtained container 1 for separation was put in a container 12 for heat medium containing a heat medium 33 so that temperature could be controlled. As the heat medium 33, water was used. As shown in FIG. 1, a trap 14 and a pressure-reducing device 15 were prepared, the glass tube 6 of the container 1 for separation was connected to the pipe 16 for reducing pressure by means of the stainless-steel union joint 10, the trap 14 was connected to the pipe 16 for reducing pressure, and the trap 14 was connected to the pressure-reducing device 15 by means of the pipe 16 for reducing pressure. As the trap 14, a trap produced by Ohkura Riken Co., Ltd, was used. As the pressure-reducing device 15, an oil-sealed rotary vacuum pump (G20DA) was used. In addition, the trap 14 was disposed in the bottomed cylindrical thermal insulation pot 17 containing liquid nitrogen 35 as a cooling medium because the trap 14 traps with cooling the steam of the membrane-permeable substances flowing in.

(Liquid Mixture)

To an aqueous solution of 10 vol % ethanol were added citric acid, malic acid, succinic acid, levulinic acid, lactic acid, isobutyric acid, n-butyric acid, propionic acid, acetic acid, and glucose as single component additional substances to prepare a liquid mixture. The citric acid, malic acid, succinic acid, levulinic acid, lactic acid, isobutyric acid, n-butyric acid, propionic acid, and acetic acid each had a concentration of 510 ppm, and the glucose had a concentration of 10000 ppm.

(Separation Operation 1)

As shown in FIG. 1, the aforementioned aqueous solution of 10 vol % ethanol (liquid mixture) 31 was put in a bottomed cylindrical container 4 (space 21 on the liquid mixture side) of the aforementioned container 1 for separation. Next, with stirring the liquid mixture 31 with a stirrer 9, the liquid mixture 31 was heated by a heat medium 33 up to 70° C., and pressure of the inside of the inner cylinder 6 (space 22 on the pressure reduction side) was reduced to 10 Pa or less. Then, the membrane-permeable substances 32 were trapped by the trap 14.

The membrane-permeable substances obtained by the above separation operation 1 were analyzed according to the following method. The obtained analysis results are shown in Table 1. In Table 1, the column of “Fed liquid” shows content (ppm) of each substance in the liquid mixture before the separation operation, and the column of “After PV treatment” shows content (ppm) of each substance with respect to the entire membrane-permeable substances after separation operation.

(Analysis of Membrane-Permeable Substances)

Separator: DX-500 (trade name) produced by Dionex Corporation

Analysis method: Ion chromatography analysis, Detector: conductance meter

TABLE 1

| | | | | After PV |
|---|---|---|---|---|
| | | Molecular | Fed liquid | treatment |
| Group | Substance | weight | (ppm) | (ppm) |
| Saccharide | glucose | 180 | 9805 | 0 |
| Organic acid | Citric acid | 192.13 | 480 | 0 |
| | Malic acid | 134.09 | 510 | 0 |
| | Succinic acid | 118.09 | 510 | 0 |
| | Levulinic acid | 116.12 | 510 | 4 |
| | Lactic acid | 90.08 | 510 | 16 |
| | Isobutyric acid | 88.11 | 510 | 470 |
| | n-butyric acid | 88.11 | 520 | 4200 |
| | Propionic acid | 74.08 | 520 | 3900 |
| | Acetic acid | 60.05 | 510 | 1800 |

(Separation Operation 2)

As shown in FIG. 1, the aqueous solution of 10 vol % ethanol (liquid mixture) 31 was put in a bottomed cylindrical container 4 (space 21 on the liquid mixture side) of the aforementioned container 1 for separation. Next, with stirring the liquid mixture 31 with a stirrer 9, the liquid mixture 31 was heated by a heat medium 33 up to 70° C., and pressure of the inside of the inner cylinder 6 (space 22 on the pressure reduction side) was reduced to 10⁻² to 8×10⁴ Pa. Then, the membrane-permeable substances 32 were trapped by the trap 14.

The permeation amount (kg/m²h) was calculated from the amount of membrane-permeable substances trapped by the above separation operation 2 and the membrane area. Table 2 shows the results of measurement for degree of vacuum (Pa) and permeation amount.

TABLE 2

| Degree of vacuum (Pa) | Permeation amount (kg/m²h) |
|---|---|
| 10⁻² | 3.8 |
| 10⁻¹ | 3.8 |
| 10 | 3.6 |
| 10² | 2.8 |
| 10³ | 2.7 |
| 10⁴ | 1.1 |
| 5 × 10⁴ | 0.5 |
| 8 × 10⁴ | 0.1 |

(Separation Operation 3)

As shown in FIG. 1, the aforementioned aqueous solution of 10 vol % ethanol 31 was put in a bottomed cylindrical container 4 (space 21 on the liquid mixture side) of the aforementioned container 1 for separation. Next, with stirring the liquid mixture 31 with a stirrer 9, the liquid mixture 31 was heated by a heat medium 33 up to 20 to 70° C., and pressure of the inside of the inner cylinder 6 (space 22 on the pressure reduction side) was reduced to 10 Pa or less. Then, the membrane-permeable substances 32 were trapped by the trap 14.

The permeation amount (kg/m²h) was calculated from the amount of membrane-permeable substances trapped by the above separation operation 3 and the membrane area. Table 3 shows the results of measurement for temperature and permeation amount.

TABLE 3

| Temperature (° C.) | Permeation amount (kg/m²h) |
|---|---|
| 20 | 0.2 |
| 50 | 1.2 |
| 70 | 3.7 |

### INDUSTRIAL APPLICABILITY

The present invention can be used as a method of separating a liquid mixture for separating a specific substance having low molecular weight from a liquid mixture. Particularly, the present invention can be used as a method of separating a liquid mixture, the method being capable of separating a specific substance for a liquid mixture without requiring high energy costs and excellent in durability of a separation membrane in a separation treatment, the separation performance of the method being hardly influenced by ionicity of a membrane-permeable substance, and the method being capable of separating ethanol from a liquid mixture of ethanol and water with high efficiency.

1. A method of separating a liquid mixture, the method selectively separating a substance having a molecular weight of 90 or more from a liquid mixture by a separation membrane; wherein the separation membrane is a MFI type zeolite membrane, the liquid mixture is brought into contact with a face on one side of the MFI type zeolite, and pressure is reduced on the other side of the MFI type zeolite membrane to allow the substance having a molecular weight of below 90 to permeate the MFI type zeolite membrane.

2. The method of separating a liquid mixture according to claim 1, wherein the liquid mixture is a solution containing an organic acid and/or a saccharide.

3. The method of separating a liquid mixture according to claim 1, wherein the liquid mixture contains at least one kind selected from the group consisting of glucose, citric acid, malic acid, succinic acid, levulinic acid, and lactic acid.

4. The method of separating a liquid mixture according to claim 1, wherein the liquid mixture contains at least one kind selected from the group consisting of isobutyric acid, normal butyric acid, propionic acid, and acetic acid.

5. The method of separating a liquid mixture according to claim 1, wherein the liquid mixture contains an organic solvent.

6. The method of separating a liquid mixture according to claim 1, wherein the liquid mixture contains water.

7. The method of separating a liquid mixture according to claim 5, wherein the organic solvent is ethanol.

8. The method of separating a liquid mixture according to claim 2, wherein the liquid mixture contains at least one kind selected from the group consisting of glucose, citric acid, malic acid, succinic acid, levulinic acid, and lactic acid.

9. The method of separating a liquid mixture according to claim 2, wherein the liquid mixture contains at least one kind selected from the group consisting of isobutyric acid, normal butyric acid, propionic acid, and acetic acid.

10. The method of separating a liquid mixture according to claim 2, wherein the liquid mixture contains an organic solvent.
